(19) United States
(12) Patent Application Publication
(10) Pub. No.: US 2025/0038935 A1
(43) Pub. Date: Jan. 30, 2025

(54) RESOURCE BLOCK PATTERN FOR PUNCTURED PHYSICAL BROADCAST CHANNEL

(71) Applicant: Nokia Technologies Oy, Espoo (FI)

(72) Inventors: Kari Juhani HOOLI, Oulu (FI); Sami-Jukka HAKOLA, Oulu (FI); Esa Tapani TIIROLA, Oulu (FI); Jorma Johannes KAIKKONEN, Oulu (FI); Pasi Eino Tapio KINNUNEN, Oulu (FI)

(21) Appl. No.: 18/712,996

(22) PCT Filed: Nov. 30, 2021
(86) PCT No.: PCT/EP2021/083485

§ 371 Date: May 23, 2024

(51) Int. Cl. H04L 5/00; H04W 72/0453

(52) U.S. Cl. CPC H04L 5/0094; H04W 72/0453

(57) ABSTRACT

Disclosed is a method comprising receiving an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel; and detecting the physical broadcast channel based at least partly on the at least one resource block pattern.

### FIELD

The following exemplary embodiments relate to wireless communication.

### BACKGROUND

As resources are limited, it is desirable to optimize the usage of network resources. A terminal device may be utilized to enable better usage of resources and enhanced user experience to a user of the terminal device.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: receive an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel; and detect the physical broadcast channel based at least partly on the at least one resource block pattern.

According to another aspect, there is provided an apparatus comprising means for: receiving an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel; and detecting the physical broadcast channel based at least partly on the at least one resource block pattern.

According to another aspect, there is provided a method comprising: receiving, by a terminal device, an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel; and detecting, by the terminal device, the physical broadcast channel based at least partly on the at least one resource block pattern.

According to another aspect, there is provided a computer program product comprising program instructions which, when run on a computing apparatus, cause the computing apparatus to perform at least the following: receiving an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel; and detecting the physical broadcast channel based at least partly on the at least one resource block pattern.

According to another aspect, there is provided a computer program comprising instructions for causing an apparatus to perform at least the following: receiving an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel; and detecting the physical broadcast channel based at least partly on the at least one resource block pattern.

According to another aspect, there is provided a computer readable medium comprising program instructions for causing an apparatus to perform at least the following: receiving an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel; and detecting the physical broadcast channel based at least partly on the at least one resource block pattern.

According to another aspect, there is provided a non-transitory computer readable medium comprising program instructions for causing an apparatus to perform at least the following: receiving an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel; and detecting the physical broadcast channel based at least partly on the at least one resource block pattern.

According to another aspect, there is provided an apparatus comprising at least one processor, and at least one memory including computer program code, wherein the at least one memory and the computer program code are configured, with the at least one processor, to cause the apparatus to: transmit, to a terminal device, an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel.

According to another aspect, there is provided an apparatus comprising means for: transmitting, to a terminal device, an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel.

According to another aspect, there is provided a method comprising: transmitting, by a network element of a wireless communication network, to a terminal device, an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel.

According to another aspect, there is provided a computer program comprising instructions for causing an apparatus to perform at least the following: transmitting, to a terminal device, an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel.

According to another aspect, there is provided a computer program product comprising program instructions which, when run on a computing apparatus, cause the computing apparatus to perform at least the following: transmitting, to a terminal device, an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel.

According to another aspect, there is provided a computer readable medium comprising program instructions for causing an apparatus to perform at least the following: transmitting, to a terminal device, an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel.

According to another aspect, there is provided a non-transitory computer readable medium comprising program instructions for causing an apparatus to perform at least the following: transmitting, to a terminal device, an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel.

According to another aspect, there is provided a system comprising at least a terminal device and a network element of a wireless communication network. The network element is configured to: transmit, to the terminal device, an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel. The terminal device is configured to: receive, from the network element, the indication indicating the at least one resource block pattern; and detect the physical broadcast channel based at least partly on the at least one resource block pattern.

According to another aspect, there is provided a system comprising at least a terminal device and a network element of a wireless communication network. The network element comprises means for: transmitting, to the terminal device, an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel. The terminal device comprises means for: receiving, from the network element, the indication indicating the at least one resource block pattern; and detecting the physical broadcast channel based at least partly on the at least one resource block pattern.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates examples of parallel deployment options for new radio and global system for mobile communications railway;

FIG. 3 illustrates new radio initial access signals and channels;

FIG. 4 illustrates an example of a physical broadcast channel with asymmetrical puncturing;

FIG. 5 illustrates a signaling diagram according to some exemplary embodiments;

FIGS. 6-7 illustrate flow charts according to some exemplary embodiments;

FIGS. 8-9 illustrate examples of physical broadcast channel resource block patterns;

FIGS. 10-11 illustrate apparatuses according to some exemplary embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

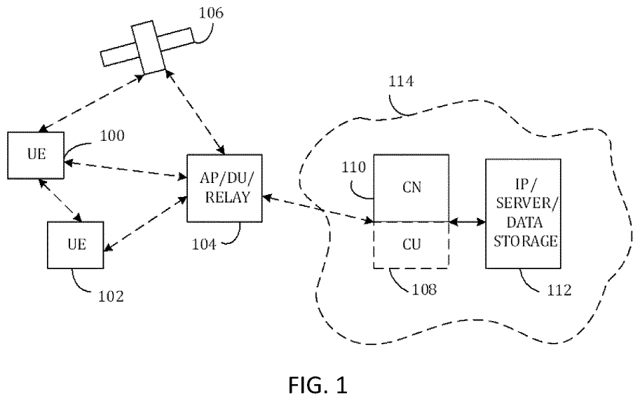

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g) NodeB) 104 providing the cell. The physical link from a user device to a (e/g) NodeB may be called uplink or reverse link and the physical link from the (e/g) NodeB to the user device may be called downlink or forward link. It should be appreciated that (e/g) NodeBs or their functionalities may be implemented by using any node, host, server or access point etc. entity suitable for such a usage.

A communication system may comprise more than one (e/g) NodeB, in which case the (e/g) NodeBs may also be configured to communicate with one another over links, wired or wireless, designed for the purpose. These links may be used for signaling purposes. The (e/g) NodeB may be a computing device configured to control the radio resources of communication system it is coupled to. The (e/g) NodeB may also be referred to as a base station, an access point or any other type of interfacing device including a relay station capable of operating in a wireless environment. The (e/g) NodeB may include or be coupled to transceivers. From the transceivers of the (e/g) NodeB, a connection may be provided to an antenna unit that establishes bi-directional radio links to user devices. The antenna unit may comprise a plurality of antennas or antenna elements. The (e/g) NodeB may further be connected to core network 110 (CN or next generation core NGC). Depending on the system, the counterpart on the CN side may be a serving gateway (S-GW, routing and forwarding user data packets), packet data network gateway (P-GW) for providing connectivity of user devices (UEs) to external packet data networks, mobility management entity (MME), access and mobility management function (AMF), or location management function (LMF), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and UE(s) and/or between the IAB node and other IAB nodes (multi-hop scenario).

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may also comprise other apparatuses, such as physical layer relay nodes or other network elements, etc. At least one of the (e/g) NodeBs or may be a Home (e/g) nodeB.

Furthermore, the (e/g) nodeB or base station may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) or a centralized unit that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the (e/g) nodeB or base station. The DU may be defined as a logical node hosting radio link control (RLC), medium access control (MAC) and/or physical (PHY) layers of the (e/g) nodeB or base station. The operation of the DU may be at least partly controlled by the CU. The CU may comprise a control plane (CU-CP), which may be defined as a logical node hosting the RRC and the control plane part of the PDCP protocol of the CU for the (e/g) nodeB or base station. The CU may further comprise a user plane (CU-UP), which may be defined as a logical node hosting the user plane part of the PDCP protocol and the SDAP protocol of the CU for the (e/g) nodeB or base station.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. In multilayer networks, one access node may provide one kind of a cell or cells, and thus a plurality of (e/g) NodeBs may be needed to provide such a network structure.

For fulfilling the need for improving the deployment and performance of communication systems, the concept of “plug-and-play” (e/g) NodeBs may be introduced. A network which may be able to use “plug-and-play” (e/g) NodeBs, may include, in addition to Home (e/g) NodeBs (H (e/g) nodeBs), a home node B gateway, or HNB-GW (not shown in FIG. 1). A HNB Gateway (HNB-GW), which may be installed within an operator's network, may aggregate traffic from a large number of HNBs back to a core network.

In some scenarios (e.g., railway communications, smart grids, public safety, and machine type communication), it may be beneficial to enable the operation of 5G NR in a narrower bandwidth than the 5 MHz channel, for which it was originally designed. Such operation may be referred to as narrowband (NB) NR. NB NR may be part of NR Rel-18 and beyond. It can be considered to be part of 5G-Advanced.

For example, deployment of NR in the 900 MHz future railway mobile communication system (FRMCS) band (i.e., corresponding to frequency band n100) may take place alongside (i.e., in parallel operation with) the legacy GSM railway (GSM-R) carriers within a 5.6 MHz bandwidth, which permits approximately 3.6 MHz to be used for NR (depending on the number of parallel GSM-R channels needed). Similarly, there may be some cases, in which 3 MHz channels are available for NR. Examples of such bands are n8, n26 and n28. It should be noted that NB NR may also be applied in other frequency bands than n100, n8, n26 and n28.

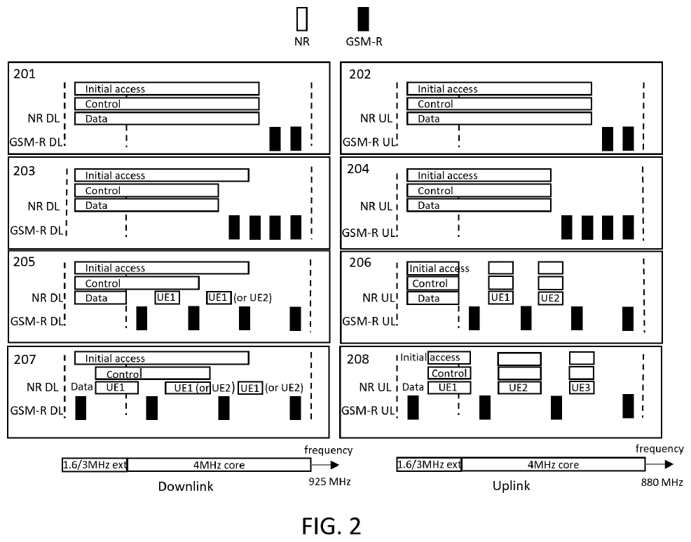

FIG. 2 illustrates examples of parallel deployment options for NR and GSM-R within a 5.6 MHz bandwidth. Block 201 illustrates adjacent channel deployment for downlink, and block 202 illustrates adjacent channel deployment for uplink. Block 203 illustrates overlay deployment with compact GSM-R channel placement for downlink, and block 204 illustrates overlay deployment with compact GSM-R channel placement for uplink. Block 205 illustrates overlay deployment with GSM-R channels distributed over 4 MHz core band for downlink, and block 206 illustrates overlay deployment with GSM-R channels distributed over 4 MHz core band for uplink. Block 207 illustrates overlay deployment with GSM-R channels distributed over full ER-GSM band for downlink, and block 208 illustrates overlay deployment with GSM-R channels distributed over full ER-GSM band for uplink.

Adjacent channel deployment (e.g., blocks 201 and 202 of FIG. 2) may result in an easier implementation for the NR scheduler, as well as just one boundary between NR and GSM-R (i.e., simpler and more predictable coexistence).

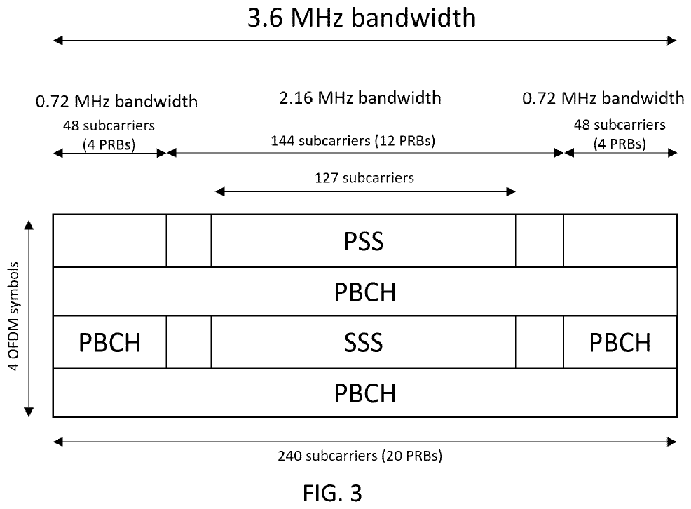

The signals and channels transmitted by NR base stations (gNBs) were not originally designed for transmission in such narrow channels, as shown in FIG. 3.

FIG. 3 illustrates NR initial access signals and channels with 15 kHz subcarrier spacing. The NR initial access signals and channels include the primary synchronization signal (PSS), secondary synchronization signal (SSS), and physical broadcast channel (PBCH). In FIG. 3, PRB is an abbreviation for physical resource block, and OFDM is an abbreviation for orthogonal frequency-division multiplexing.

During cell search operations which may carried out when a UE is powered on, mobility in connected mode, idle mode mobility (e.g., reselections), inter-RAT mobility to NR system etc., the UE uses NR synchronization signals and PBCH to derive the information needed to access the target cell. The PSS and SSS may be periodically transmitted on the downlink from the target cell. Once the UE successfully detects the PSS and/or SSS, it gains the knowledge about synchronization and physical cell identity (PCI) of the cell, and the UE is then ready to decode the PBCH. The PSS and SSS along with PBCH can be jointly referred to as a synchronization signal block (SSB). The PBCH carries information needed for further system access, for example to acquire the system information block type 1 (SIB1) of the target cell.

In NR, the UE may receive the target cell SIB1 in dedicatedSIB1-Delivery in the RRCReconfiguration information element (IE) triggering a handover. Even in that case, when the UE synchronizes to the target cell at below 3 GHz frequency, the UE needs to detect the demodulation reference signal (DMRS) associated to the PBCH to obtain the SSB index and radio frame timing (whether it is the first or second half of a 10 ms radio frame), as well as to decode the PBCH to obtain the system frame number (SFN) based on a combination of master information block (MIB) payload and blind decoding trials of MIB. The PBCH DMRS is a reference signal that may be used by the UE to decode the associated PBCH. The PBCH DMRS can also be used for reference signal received power (RSRP) measurements.

Some previous discussions of the possibility of using NR in a narrower bandwidth than 5 MHz have assumed that the synchronization signals and system information transmissions would have to be redesigned. This redesign may be based on, for example, smaller subcarrier spacing (e.g., 7.5 kHz), or a new SSB structure. This would be a very fundamental change to the design of NR, which would adversely impact the ecosystem. As the total number of railway NR devices is relatively small, it may not be desirable to implement such changes to the UE physical layer processing on the hardware to ensure chipset support in a timely manner.

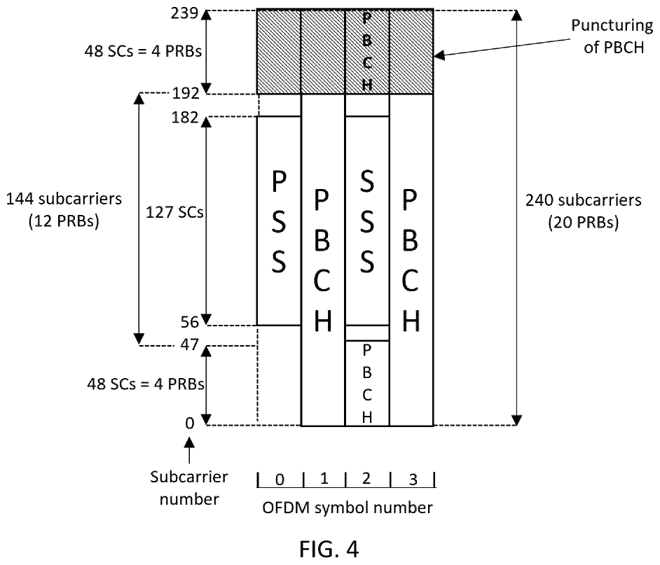

A different mechanism to adapt NR to such narrower bandwidths is therefore needed, such as puncturing the PBCH rather than recoding and remapping it. Illustration of such a case is provided in FIG. 4. Herein puncturing means that the punctured frequency resources are left without a signal in the transmitter. Thus, the time-domain signal in transmitting antennas does not carry those frequency components in the carrier, when puncturing is applied. In other words, the base station may prepare the PBCH (encoding, mapping to physical resources, etc.), but the punctured PBCH resource blocks are not transmitted (and just the non-punctured PBCH resource block are transmitted). Punctured PBCH may be needed to narrow down the bandwidth of SSB to match the available bandwidth. The negative performance impact of puncturing may be compensated by a power boost, where the transmission power of the punctured resource blocks is allocated at least partially for the non-punctured resource blocks.

FIG. 4 illustrates an example of PBCH with asymmetrical puncturing. A given SSB may occupy 4 OFDM symbols in time domain with 240 subcarriers (SC) in frequency domain with 20 PRBs, wherein the SSB comprises PSS, SSS and PBCH in consecutive OFDM symbols. The first OFDM symbol is PSS, the second OFDM symbol is PBCH, the third OFDM symbol is SSS and PBCH, and the fourth OFDM symbol is PBCH.

In FIG. 4, four PRBs are punctured asymmetrically from the highest frequencies. The amount of puncturing and the location of the punctured PRBs may vary according to a specific scenario, such as frequency bandwidth available for operator, number of GSM-R channels coexisting with NB NR cell, and the location of the cell (the number of required GMS-R channels may depend on whether it covers a railway yard, railway with multiple tracks, etc.). The number of GSM-R channels may decrease in the future due to the decreasing use of GSM-R and increasing use of NB NR. It should be noted that both GSM-R and NB NR may be operated by the same operator.

It may be assumed that the amount of puncturing within a cell does not vary dynamically. On the other hand, a scenario where PBCH puncturing varies dynamically cannot be ruled out as one potential scenario.

Some exemplary embodiments relate to punctured PBCH detection during handover. Some exemplary may provide an enhancement to NR handover for narrow bandwidth operation, so that the UE can avoid blind (or semi-blind) detection of PBCH bandwidth on the target cell of the handover.

In some exemplary embodiments, prior to the handover, the UE is informed whether the target cell PBCH is punctured and, in case of puncturing, which resource blocks are used in the transmission of PBCH. This may be done by indicating a PBCH resource block pattern from a set of pre-defined patterns. The PBCH resource block pattern may also be referred to as a PBCH transmission pattern or a PBCH puncturing pattern. A resource block may also be referred to as a physical resource block or PRB herein.

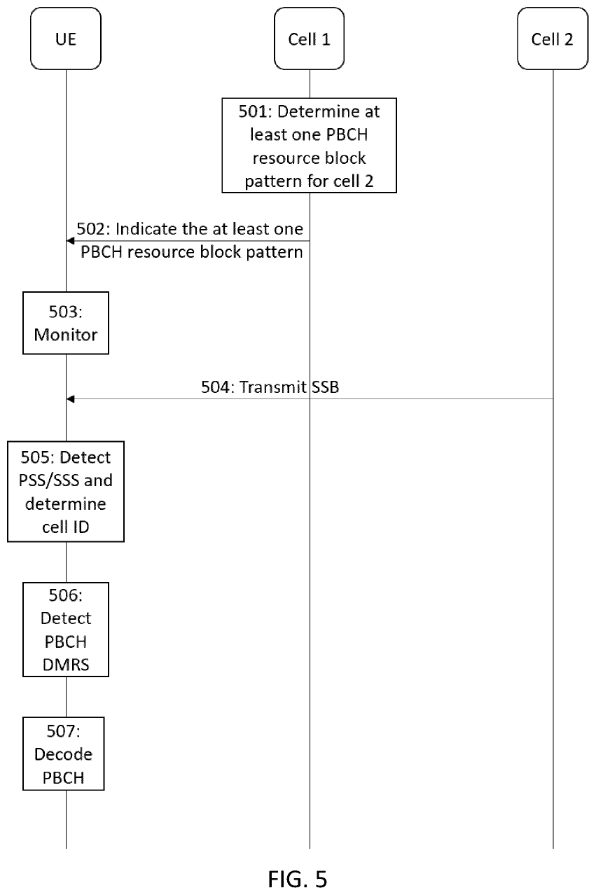

FIG. 5 illustrates a signaling diagram according to an exemplary embodiment.

Referring to FIG. 5, a network element of a wireless communication network determines 501 at least one resource block pattern for PBCH for a second cell (cell 2). The network element may control a first cell (cell 1), which is the serving cell of a UE (e.g., NR UE). For example, the network element may comprise, or be comprised in, a base station (e.g., narrowband NR gNB) or a DU.

The at least one resource block pattern may be determined based at least partly on information received from the second cell and/or from the network. Adaptation into GSM carrier allocation in adjacent NR carriers may be used as criteria by the network for selecting the at least one resource block pattern. Alternatively or additionally, interference measurements by the NR UE and/or the network element (e.g., NR gNB), or network planning in a given NB site by an operator, may be used for selecting the at least one resource block pattern.

The network element indicates 502 the at least one resource block pattern to the UE, wherein the at least one resource block pattern indicates at least one non-punctured resource block used for transmission of PBCH from the second cell, and at least one punctured resource block that is not used for the transmission of PBCH from the second cell. In other words, the at least one resource block pattern indicates which resource block(s) are used for transmission of PBCH DMRS and PBCH data (payload) from the second cell, and which resource blocks are punctured. Alternatively, all resource blocks in the at least one resource block pattern may be non-punctured.

The UE may be pre-configured with a set of pre-defined resource block patterns (i.e., a plurality of pre-defined resource block patterns), and the indicated at least one resource block pattern may be comprised in the set of pre-defined resource block patterns. The indication 502 may indicate, for example, an index of the at least one resource block pattern from the set of pre-defined resource block patterns. As another example, the indication 502 may comprise a bitmap (e.g., 8 bits), where the first one or more (e.g., four) bits of the bitmap correspond to one or more (e.g., four) lower resource blocks of PBCH, and the last one or more (e.g., four) bits of the bitmap correspond to one or more (e.g., four) highest resource blocks of PBCH, respectively.

The indication may further indicate a channel bandwidth (CBW) associated with the at least one resource block pattern. For example, if the number of resource blocks in the at least one resource block pattern is at most 15, then the UE may assume 3 MHZ CBW for NR. As another example, if the number of resource blocks in the at least one resource block pattern is more than 15, then the UE may assume 5 MHz CBW for NR. The CBW assumption may impact the UE radio frequency (RF) configuration. The PBCH bandwidth (or resource block pattern) may vary from cell to cell, for example depending on the GSM-R load. It may also vary in time according to the operator's migration plan from GSM-R to NR. At the beginning of the migration (when GSM-R and NR are operated in parallel), the number of resource blocks available for NR may be smaller (e.g., 15 PRBs corresponding to a 3 MHz CBW). However, the number of resource blocks available for NR may gradually increase, and it may eventually cover 5 MHz CBW (i.e., 25 PRBs).

The at least one PBCH resource block pattern may be indicated, for example, in a dedicated information field in an RRC reconfiguration (RRCReconfiguration) message or in an RRC resume (RRCResume) message transmitted from the network element to the UE. For example, the information field may be included in the otherConfig information element comprised in the RRC reconfiguration message. The RRC reconfiguration message may also comprise handover-related information (e.g., a handover command) for performing a handover from the first cell to the second cell. In other words, the first cell is the source cell, and the second cell is the target cell of the handover. Thus, the UE may use the information comprised in the RRC reconfiguration message for completing the handover to the second cell.

As another example, the at least one resource block pattern may be indicated to the UE in one or more measurement configuration messages, so that the UE can take the correct assumption into account, when searching for cells and decoding the PBCH of found cells.

The indication 502 may further indicate the scope, in which the at least one resource block pattern is valid. For example, the scope may be indicated as a list of one or more cells, for which the at least one resource block pattern is valid. In this case, for other cells on the frequency layer, the UE may assume full PBCH bandwidth or (specific) puncturing, which may be pre-defined or pre-configured. Alternatively, the scope may comprise all cells on a certain frequency layer indicated by the indication.

The UE monitors 503 PBCH based at least partly on the at least one resource block pattern indicated to the UE. In other words, the UE may monitor the PBCH in the time and frequency domains as indicated by the at least one non-punctured resource block of the at least one resource block pattern. The UE does not monitor the PBCH on the at least one punctured resource block of the at least one resource block pattern.

A network element controlling the second cell transmits 504 (broadcasts) an SSB, while the UE is monitoring the PBCH. The SSB comprises a PSS, a SSS and the PBCH. The second cell may be a neighbour cell of the first cell. The first cell and the second cell may be controlled by a single network element (e.g., narrowband NR gNB or DU), or they may be controlled by different network elements (e.g., narrowband NR gNBs or DUs).

The UE detects 505 and decodes the PSS and/or the SSS transmitted by the network element controlling the second cell. Upon successfully decoding the PSS and/or the SSS, the UE obtains information about the time and frequency synchronization as well as the PCI (i.e., cell ID) of the second cell.

The UE detects 506, based at least partly on the at least one resource block pattern, a demodulation reference signal (DMRS) associated with the PBCH to obtain the SSB index and radio frame timing (e.g., whether it is first or second half of a 10 ms radio frame). The PBCH DMRS may be detected on at least one non-punctured resource block of the at least one resource block pattern.

The UE decodes 507 the PBCH based on the PBCH DMRS. Herein decoding the PBCH may refer to decoding the PBCH data, or PBCH payload. The PBCH may comprise, for example, the MIB of the second cell. It should be noted that step 507 may also comprise PBCH demodulation, de-rate matching, and deinterleaving in addition to the actual decoding. Upon decoding the PBCH, the UE may read the MIB to obtain SFN.

In another exemplary embodiment, the indication 502 may indicate at least two resource block patterns, i.e., at least a first resource block pattern and a second resource block pattern of the set of pre-defined resource block patterns. In other words, the at least one resource block pattern may comprise at least the first resource block pattern and the second resource block pattern.

The first resource block pattern may be valid for a pre-defined (pre-determined) time window for detecting the PBCH after the transmission of the indication 502 (e.g., RRC reconfiguration message or RRC resume message). The time window may be based on the current GSM-R traffic load and/or use of frequency channels. The time window may be indicated to the UE together with the at least one resource block pattern, or the UE may determine the time window independently. The GSM-R traffic load and use of frequency channels may be obtained from GSM-R network equipment or detected over the air at the network element (e.g., narrowband NR gNB). The second resource block pattern may be semi-statically valid, such that the UE may use the second resource block pattern, if the PBCH is not decoded within the time window.

In other words, the UE may monitor the PBCH within the pre-defined time window based at least partly on the first resource block pattern. Additionally, the UE may monitor the PBCH based at least partly on the second resource block pattern, if the PBCH is not decoded within the pre-defined time window.

In one example, the first resource block pattern may comprise more non-punctured (i.e., active) resource blocks (PRBs) selected according to the (lower) GSM-R load compared to the second resource block pattern. In this case, the second resource block pattern may be more conservative (e.g., selected according to a worst-case scenario). Alternatively or additionally, the first resource block pattern may be cell-specific (i.e., specific to a single cell), and the second resource block pattern may be common for multiple cells.

It should be noted that the terms “first resource block pattern” and “second resource block pattern” are used herein to distinguish the resource block patterns, and they do not necessarily mean a specific order of the resource block patterns.

In another exemplary embodiment, the UE may be provided the SIB1 of the target cell (second cell), and based on scs-SpecificCarrierList in FrequencyInfoDL-SIB, and absoluteFrequencySSB in FrequencyInfoDL or ssbFrequency in MeasObjectNR, the UE may determine whether puncturing is applied to PBCH. The puncturing may be assumed to be applied, if the number of resource blocks indicated by scs-SpecificCarrier (in SCS-SpecificCarrierList) is below a certain threshold, for example 20 resource blocks. In case puncturing is applied, the resource blocks indicated by scs-SpecificCarrier (in SCS-SpecificCarrierList) may be assumed to be available for PBCH transmission (i.e., non-punctured). Based on the SSB frequency location based on absoluteFrequencySSB (and the assumed 20 PRB size), the PBCH resource blocks outside the resource blocks indicated by the scs-SpecificCarrier may be assumed to be punctured.

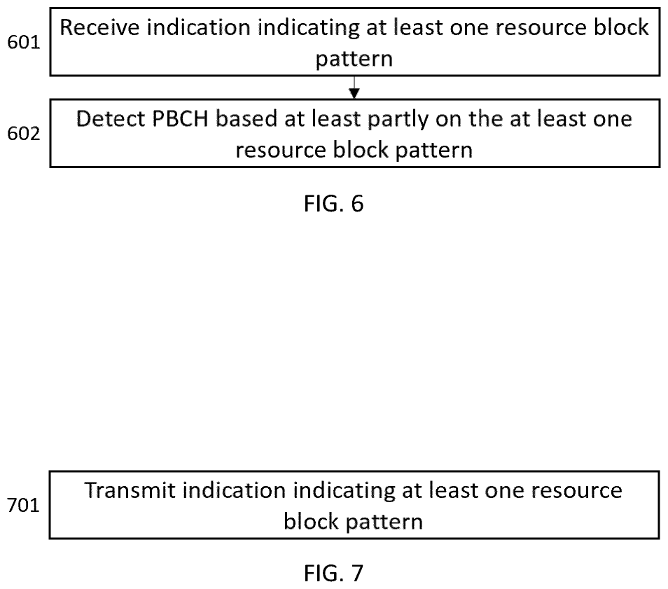

FIG. 6 illustrates a flow chart according to an exemplary embodiment. The steps illustrated in FIG. 6 may be performed by an apparatus such as, or comprised in, a terminal device. The terminal device may also be referred to as a UE or user equipment herein.

Referring to FIG. 6, an indication indicating at least one resource block pattern of a set of pre-defined resource block patterns for a physical broadcast channel (PBCH) is received 601, wherein the at least one resource block pattern indicates at least one non-punctured resource block used for transmission of the physical broadcast channel, and at least one punctured resource block that is not used for the transmission of the physical broadcast channel.

The physical broadcast channel is detected 602 based at least partly on the at least one resource block pattern.

FIG. 7 illustrates a flow chart according to an exemplary embodiment. The steps illustrated in FIG. 7 may be performed by an apparatus such as, or comprised in, a network element of a wireless communication network.

Referring to FIG. 7, an indication indicating at least one resource block pattern of a set of pre-defined resource block patterns for a physical broadcast channel is transmitted 701 to a terminal device, wherein the at least one resource block pattern indicates at least one non-punctured resource block used for transmission of the physical broadcast channel, and at least one punctured resource block that is not used for the transmission of the physical broadcast channel.

The steps and/or blocks described above by means of FIGS. 5-7 are in no absolute chronological order, and some of them may be performed simultaneously or in an order differing from the described one. Other steps and/or blocks may also be executed between them or within them.

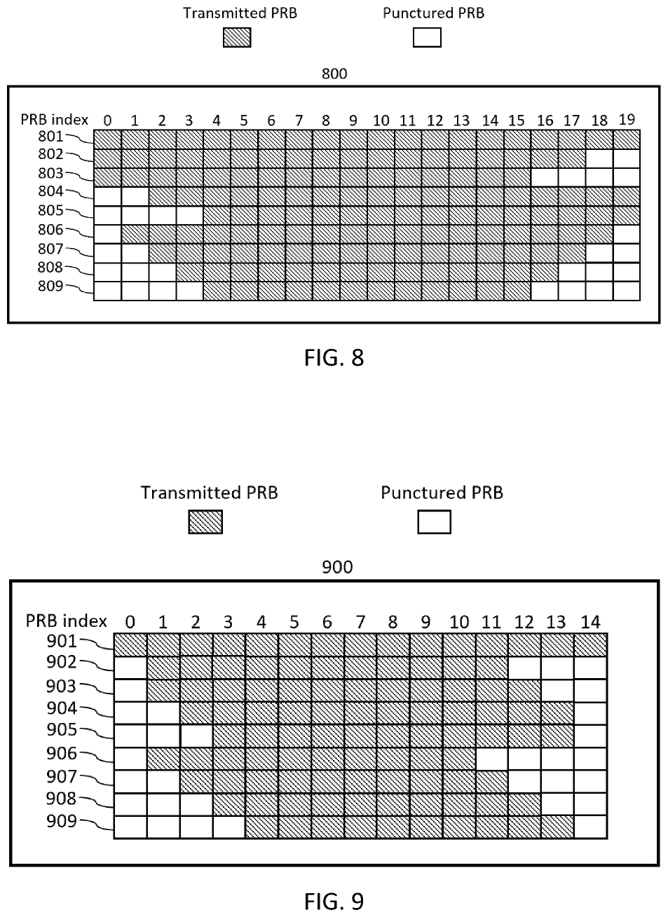

FIG. 8 illustrates a set 800 of pre-defined PBCH resource block patterns 801-809 according to an exemplary embodiment. In FIG. 8, the columns indicate PRB indices, and the rows indicate the PBCH resource block patterns 801-809. The white blocks illustrate punctured PRBs, and the blocks with the hash pattern illustrate transmitted PRBs (i.e., non-punctured PRBs that are used for transmission of PBCH).

FIG. 8 illustrates asymmetric puncturing from one side (patterns 802-805), and symmetric puncturing from two sides (patterns 806-809). In this exemplary embodiment, there are 20 resource blocks (PRBs) per pattern.

At least the 12 resource blocks in the center (i.e., PRB indices 4-15) of a given resource block pattern may be non-punctured, and the punctured resource blocks may comprise up to four outermost resource blocks in either or both sides of the SSB. In addition, it should be noted that the amount of punctured resource blocks may vary from what is shown in the patterns of FIG. 8.

At least one PBCH resource block pattern from the set 800 may be indicated to the UE from the network (source cell) for example by indicating an index associated with the at least one PBCH resource block pattern to the UE. For example, the indication may be provided as a two-bit indication providing an index to certain pattern from the set 800.

A first PBCH resource block pattern 801 (i.e., the first row) of the set 800 indicates full allocation of PRBs (i.e., no punctured PRBs).

A second PBCH resource block pattern 802 (i.e., the second row) of the set 800 indicates puncturing 2 PRBs asymmetrically from high frequency. Asymmetrical puncturing means that a different number of PRBs is punctured from high frequency than from low frequency (e.g., 2 PRBs punctured from high frequency and 0 PRBs punctured from low frequency in this case).

A third PBCH resource block pattern 803 (i.e., the third row) of the set 800 indicates puncturing 4 PRBs asymmetrically from high frequency.

A fourth PBCH resource block pattern 804 (i.e., the fourth row) of the set 800 indicates puncturing 2 PRBs asymmetrically from low frequency.

A fifth PBCH resource block pattern 805 (i.e., the fifth row) of the set 800 indicates puncturing 4 PRBs asymmetrically from low frequency.

A sixth PBCH resource block pattern 806 (i.e., the sixth row) of the set 800 indicates puncturing 2 PRBs symmetrically, wherein 1 PRB is punctured from low frequency and 1 PRB is punctured from high frequency. Symmetrical puncturing means that an equal number of PRBs is punctured from both the low frequency and the high frequency.

A seventh PBCH resource block pattern 807 (i.e., the seventh row) of the set 800 indicates puncturing 4 PRBs symmetrically, wherein 2 PRBs are punctured from low frequency and 2 PRBs are punctured from high frequency.

An eighth PBCH resource block pattern 808 (i.e., the eighth row) of the set 800 indicates puncturing 6 PRBs symmetrically, wherein 3 PRBs are punctured from low frequency and 3 PRBs are punctured from high frequency.

A ninth PBCH resource block pattern 809 (i.e., the ninth row) of the set 800 indicates puncturing 8 PRBs symmetrically, wherein 4 PRBs are punctured from low frequency and 4 PRBs are punctured from high frequency.

FIG. 9 illustrates a set 900 of pre-defined PBCH resource block patterns 901-909 according to another exemplary embodiment. In FIG. 9, the columns indicate PRB indices, and the rows indicate the PBCH resource block patterns 901-909. The white blocks illustrate punctured PRBs, and the blocks with the hash pattern illustrate transmitted PRBs (i.e., non-punctured PRBs that are used for transmission of PBCH).

FIG. 9 illustrates asymmetric puncturing from two sides. For example, asymmetric puncturing from two sides may be used to facilitate 3 MHz channel bandwidth (CBW) with 15 PRBs. For example, the punctured resource blocks may be listed as 4+1 (4 punctured PRBs from lower frequency and 1 punctured PRB from upper frequency of the SSB), 3+2, 2+3, and/or 1+4. However, the amount of punctured PRBs may also be different than 5, as shown in FIG. 9. In addition, it should be noted that the amount of punctured PRBs may vary from what is shown in the patterns of FIG. 9.

A first PBCH resource block pattern 901 (i.e., the first row) of the set 900 indicates full allocation of PRBs (i.e., no punctured PRBs).

A second PBCH resource block pattern 902 (i.e., the second row) of the set 900 indicates asymmetric puncturing of 3 PRBs from high frequency and 1 PRB from low frequency.

A third PBCH resource block pattern 903 (i.e., the third row) of the set 900 indicates asymmetric puncturing of 2 PRBs from high frequency and 1 PRB from low frequency.

A fourth PBCH resource block pattern 904 (i.e., the fourth row) of the set 900 indicates asymmetric puncturing of 1 PRB from high frequency and 2 PRBs from low frequency.

A fifth PBCH resource block pattern 905 (i.e., the fifth row) of the set 900 indicates asymmetric puncturing of 1 PRB from high frequency and 3 PRBs from low frequency.

A sixth PBCH resource block pattern 906 (i.e., the sixth row) of the set 900 indicates asymmetric puncturing of 4 PRBs from high frequency and 1 PRB from low frequency.

A seventh PBCH resource block pattern 907 (i.e., the seventh row) of the set 900 indicates asymmetric puncturing of 3 PRBs from high frequency and 2 PRBs from low frequency.

An eighth PBCH resource block pattern 908 (i.e., the eighth row) of the set 900 indicates asymmetric puncturing of 2 PRBs from high frequency and 3 PRBs from low frequency.

A ninth PBCH resource block pattern 909 (i.e., the ninth row) of the set 900 indicates asymmetric puncturing of 1 PRB from high frequency and 4 PRBs from low frequency.

It should be noted that the patterns illustrated in FIGS. 8 and 9 are only some non-limiting examples of PBCH resource block patterns, and other patterns are also possible. The amount and/or order of the patterns in the set may also be different than shown in FIGS. 8 and 9.

A technical advantage provided by some exemplary embodiments is that they may simplify and improve the performance of target cell PBCH detection and decoding in narrowband NR operation. The improvement may be significant already with relatively low puncturing levels, as can be seen below from Table 1 (no knowledge about PBCH puncturing) and Table 2 (knowledge about PBCH puncturing). The improved PBCH detection may also improve the reliability for measurements and handovers, since the PBCH is detected in a timely manner without multiple iterations over different patterns. Some exemplary embodiments may also be beneficial from the perspective of system operation, because PBCH should be detectable in cell edge conditions where the signal-to-noise ratio (SNR) operating point is low. Further advantage is that that they provide improved robustness for example for the coexistence problem (i.e., when operating GSM-R and NR in parallel).

Table 1 below shows performance degradation due to puncturing unknown by the UE. Table 2 below shows performance degradation due to PBCH puncturing, when the UE has correct knowledge of PRBs, on which PBCH DMRS and data is transmitted. In Tables 1 and 2, one-sided puncturing of PBCH, as shown in FIG. 4, is used (i.e., one side of the PBCH band is punctured). The gNB does not transmit PBCH on the punctured PRBs. On those GSM-R “PRBs”, additive white Gaussian noise (AWGN) interference is used to mimic GSM-R interference. In Tables 1 and 2, degradation on SNR (dSNR) is shown for different amounts of PRB puncturing (i.e., 2, 4, and 6 PRBs). It is the amount that SNR needs to be increased by, so that the UE reaches adequate PBCH detection performance in comparison to a reference case, where full (unpunctured) PBCH is transmitted and received.

TABLE 1

| GSM RX power | dSNR [dB] with 2 | dSNR [dB] with 4 | dSNR [dB] with 6 |
|---|---|---|---|
| level [dB] vs | PRBs compared | PRBs compared | PRBs compared |
| PBCH | to reference | to reference | to reference |
| −100 | 1.16 | 2.94 | 4.17 |
| −10 | 1.2 | 3.09 | 4.3 |
| −6 | 1.27 | 3.27 | 4.72 |
| −3 | 1.36 | 3.69 | 5.56 |
| 0 | 1.59 | 5.25 | 12.5 |

TABLE 2

| GSM RX power | dSNR [dB] with 2 | dSNR [dB] with 4 | dSNR [dB] with 6 |
|---|---|---|---|
| level [dB] vs | PRBs compared | PRBs compared | PRBs compared |
| PBCH | to reference | to reference | to reference |
| −100 | 0.89 | 2.25 | 3.17 |
| −10 | 0.92 | 2.28 | 3.19 |
| −6 | 0.94 | 2.27 | 3.17 |
| −3 | 0.94 | 2.30 | 3.2 |
| 0 | 0.97 | 2.31 | 3.23 |

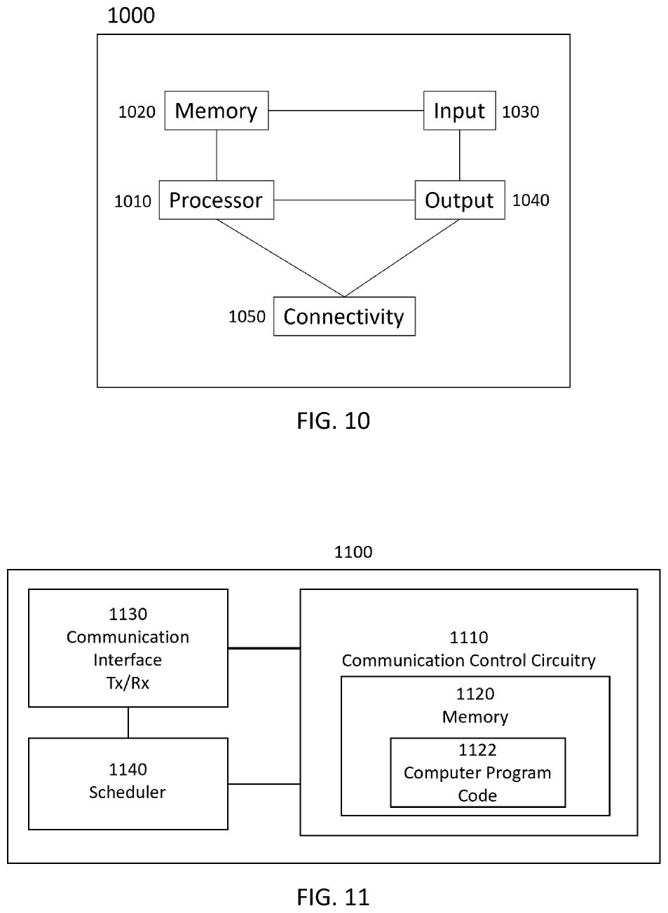

FIG. 10 illustrates an apparatus 1000, which may be an apparatus such as, or comprised in, a terminal device, according to an exemplary embodiment. The terminal device may also be referred to as a UE or user equipment herein. The apparatus 1000 comprises a processor 1010. The processor 1010 interprets computer program instructions and processes data. The processor 1010 may comprise one or more programmable processors. The processor 1010 may comprise programmable hardware with embedded firmware and may, alternatively or additionally, comprise one or more application-specific integrated circuits (ASICs).

The processor 1010 is coupled to a memory 1020. The processor is configured to read and write data to and from the memory 1020. The memory 1020 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1020 stores computer readable instructions that are executed by the processor 1010. For example, non-volatile memory stores the computer readable instructions and the processor 1010 executes the instructions using volatile memory for temporary storage of data and/or instructions.

The computer readable instructions may have been pre-stored to the memory 1020 or, alternatively or additionally, they may be received, by the apparatus, via an electromagnetic carrier signal and/or may be copied from a physical entity such as a computer program product. Execution of the computer readable instructions causes the apparatus 1000 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 1000 may further comprise, or be connected to, an input unit 1030. The input unit 1030 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1030 may comprise an interface to which external devices may connect to.

The apparatus 1000 may also comprise an output unit 1040. The output unit may comprise or be connected to one or more displays capable of rendering visual content, such as a light emitting diode (LED) display, a liquid crystal display (LCD) and/or a liquid crystal on silicon (LCoS) display. The output unit 1040 may further comprise one or more audio outputs. The one or more audio outputs may be for example loudspeakers.

The apparatus 1000 further comprises a connectivity unit 1050. The connectivity unit 1050 enables wireless connectivity to one or more external devices. The connectivity unit 1050 comprises at least one transmitter and at least one receiver that may be integrated to the apparatus 1000 or that the apparatus 1000 may be connected to. The at least one transmitter comprises at least one transmission antenna, and the at least one receiver comprises at least one receiving antenna. The connectivity unit 1050 may comprise an integrated circuit or a set of integrated circuits that provide the wireless communication capability for the apparatus 1000. Alternatively, the wireless connectivity may be a hardwired application-specific integrated circuit (ASIC). The connectivity unit 1050 may comprise one or more components such as a power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 1000 may further comprise various components not illustrated in FIG. 10. The various components may be hardware components and/or software components.

The apparatus 1100 of FIG. 11 illustrates an exemplary embodiment of an apparatus such as, or comprised in, a network element of a wireless communication network. The network element may also be referred to, for example, as a network node, a RAN node, a NodeB, an LTE evolved NodeB (eNB), a gNB, a narrowband NR gNB, a base station, an NR base station, a 5G base station, an access node, an access point (AP), a distributed unit (DU), a central unit (CU), a baseband unit (BBU), a radio unit (RU), a radio head, a remote radio head (RRH), or a transmission and reception point (TRP). The apparatus 1100 may comprise, for example, a circuitry or a chipset applicable for realizing some of the described exemplary embodiments. The apparatus 1100 may be an electronic device comprising one or more electronic circuitries. The apparatus 1100 may comprise a communication control circuitry 1110 such as at least one processor, and at least one memory 1120 including a computer program code (software) 1122 wherein the at least one memory and the computer program code (software) 1122 are configured, with the at least one processor, to cause the apparatus 1100 to carry out some of the exemplary embodiments described above.

The processor is coupled to the memory 1120. The processor is configured to read and write data to and from the memory 1120. The memory 1120 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1120 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1120 or, alternatively or additionally, they may be received, by the apparatus, via an electromagnetic carrier signal and/or may be copied from a physical entity such as a computer program product. Execution of the computer readable instructions causes the apparatus 1100 to perform one or more of the functionalities described above.

The memory 1120 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some exemplary embodiments, structures of the frames used in the detected neighbour cells.

The apparatus 1100 may further comprise a communication interface 1130 comprising hardware and/or software for realizing communication connectivity according to one or more communication protocols. The communication interface 1130 comprises at least one transmitter (Tx) and at least one receiver (Rx) that may be integrated to the apparatus 1100 or that the apparatus 1100 may be connected to. The communication interface 1130 provides the apparatus with radio communication capabilities to communicate in the cellular communication system. The communication interface may, for example, provide a radio interface to terminal devices. The apparatus 1100 may further comprise another interface towards a core network such as the network coordinator apparatus and/or to the access nodes of the cellular communication system. The apparatus 1100 may further comprise a scheduler 1140 that is configured to allocate resources.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s)), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, microcontrollers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

### LIST OF ABBREVIATIONS

4G: fourth generation
5G: fifth generation
ADC: analog-to-digital converter
AP: access point
ASIC: application-specific integrated circuit
AWGN: additive white Gaussian noise
BBU: baseband unit
CBW: channel bandwidth
CN: core network
CPS: cyber-physical system
CSSP: customer-specific standard product
CU: central unit
CU-CP: central unit control plane
CU-UP: central unit user plane
DAC: digital-to-analog converter
DFE: digital front end
DMRS: demodulation reference signal
DRAM: dynamic random-access memory
dSNR: degradation on signal-to-noise ratio
DSP: digital signal processor
DSPD: digital signal processing device
DU: distributed unit
EEPROM: electronically erasable programmable read-only memory
FPGA: field programmable gate array
FRMCS: future railway mobile communication system
GEO: geostationary earth orbit
gNB: next generation nodeB/5G base station
GPU: graphics processing unit
GSM-R: global system for mobile communications railway
HNB-GW: home node B gateway
IAB: integrated access and backhaul
ID: identity
IE: information element
IMS: internet protocol multimedia subsystem
IoT: internet of things
L1: Layer 1
L2: Layer 2
L3: Layer 3
LCD: liquid crystal display
LCOS: liquid crystal on silicon
LED: light emitting diode
LEO: low earth orbit
LTE: long term evolution
LTE-A: long term evolution advanced
M2M: machine-to-machine
MAC: medium access control
MANET: mobile ad-hod network
MEC: multi-access edge computing
MIB: master information block
MIMO: multiple input and multiple output
MME: mobility management entity
mMTC: massive machine-type communications
MT: mobile termination
NB: narrowband
NFV: network function virtualization
NGC: next generation core
NR: new radio
OFDM: orthogonal frequency-division multiplexing
PBCH: physical broadcast channel
PCI: physical cell identity
PCS: personal communications services
PDA: personal digital assistant
PDCP: packet data convergence protocol
P-GW: packet data network gateway
PHY: physical
PLD: programmable logic device
PRB: physical resource block
PROM: programmable read-only memory
PSS: primary synchronization signal
RAM: random-access memory
RAN: radio access network
RAP: radio access point
RAT: radio access technology
RF: radio frequency
RI: radio interface
RLC: radio link control
ROM: read-only memory
RRC: radio resource control
RRH: remote radio head
RSRP: reference signal received power
RU: radio unit
RX: receiver
SC: subcarrier
SDAP: service data adaptation protocol
SDN: software defined networking
SDRAM: synchronous dynamic random-access memory
SFN: system frame number
S-GW: serving gateway
SIB1: system information block type 1
SIM: subscriber identification module
SNR: signal-to-noise ratio
SoC: system-on-a-chip
SSB: synchronization signal block
SSS: secondary synchronization signal
TRP: transmission and reception point
TRX: transceiver
TX: transmitter
UE: user equipment/terminal device
UMTS: universal mobile telecommunications system
UTRAN: UMTS radio access network
UWB: ultra-wideband
vCU: virtualized central unit
vDU: virtualized distributed unit
WCDMA: wideband code division multiple access
WiMAX: worldwide interoperability for microwave access
WLAN: wireless local area network

1. An apparatus comprising at least one processor, and at least one memory including computer program code, wherein the at least one memory and the computer program code are configured, with the at least one processor, to cause the apparatus to:
receive an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel; and
detect the physical broadcast channel based at least partly on the at least one resource block pattern.

2. The apparatus according to claim 1, wherein the physical broadcast channel is detected on the at least one non-punctured resource block.

3. The apparatus according to claim 1, wherein the indication indicates at least a first resource block pattern and a second resource block pattern of the set of pre-defined resource block patterns, wherein the first resource block pattern is valid for a pre-defined time window.

4. The apparatus according to claim 3, wherein the apparatus is further caused to:
detect the physical broadcast channel within the pre-defined time window based at least partly on the first resource block pattern; and
decode the physical broadcast channel within the pre-defined time window.

5. The apparatus according to claim 3, wherein the apparatus is further caused to:
detect the physical broadcast channel based at least partly on the second resource block pattern, if the physical broadcast channel is not decoded within the pre-defined time window; and
decode the physical broadcast channel.

6. The apparatus according to claim 3, wherein the first resource block pattern comprises more non-punctured resource blocks than the second resource block pattern.

7. The apparatus according to claim 3, wherein the first resource block pattern is cell-specific, and the second resource block pattern is common for multiple cells.

8. The apparatus according to claim 1, wherein the indication further indicates a list of one or more cells, for which the at least one resource block pattern is valid;
wherein the physical broadcast channel is detected in one of the one or more cells based at least partly on the at least one resource block pattern.

9. The apparatus according to claim 1, wherein the indication further indicates that the at least one resource block pattern is valid for all cells on a frequency layer indicated by the indication.

10. The apparatus according to claim 1, wherein the indication further indicates a channel bandwidth associated with the at least one resource block pattern.

11. The apparatus according to claim 1, wherein the apparatus comprises, or is comprised in, a terminal device.

12. An apparatus comprising at least one processor, and at least one memory including computer program code, wherein the at least one memory and the computer program code are configured, with the at least one processor, to cause the apparatus to:
transmit, to a terminal device, an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel.

13. The apparatus according to claim 12, wherein the indication indicates at least a first resource block pattern and a second resource block pattern of the set of pre-defined resource block patterns, wherein the first resource block pattern is valid for a pre-defined time window.

14. The apparatus according to claim 13, wherein the first resource block pattern comprises more non-punctured resource blocks than the second resource block pattern.

15. The apparatus according to claim 13, wherein the first resource block pattern is cell-specific, and the second resource block pattern is common for multiple cells.

16. The apparatus according to claim 12, wherein the indication further indicates a list of one or more cells, for which the at least one resource block pattern is valid.

17. The apparatus according to claim 12, wherein the indication further indicates that the at least one resource block pattern is valid for all cells on a frequency layer indicated by the indication.

18. The apparatus according to claim 12, wherein the indication further indicates a channel bandwidth associated with the at least one resource block pattern.

19. The apparatus according to claim 12, wherein the apparatus comprises, or is comprised in, a network element of a wireless communication network.

20.-21. (canceled)

22. A method comprising:
receiving, by a terminal device, an indication indicating at least one resource block pattern of a set of pre-defined resource block patterns for a physical broadcast channel, wherein the at least one resource block pattern indicates at least one non-punctured resource block used for transmission of the physical broadcast channel, and at least one punctured resource block that is not used for the transmission of the physical broadcast channel; and
detecting, by the terminal device, the physical broadcast channel based at least partly on the at least one resource block pattern.

23.-27. (canceled)
